(19) United States
(12) Patent Application Publication
(10) Pub. No.: US 2026/0153758 A1
(43) Pub. Date: Jun. 4, 2026

(54) PHOTONIC INTEGRATED CIRCUIT AND METHODS RELATED TO THE PHOTONIC INTEGRATED CIRCUIT

(71) Applicant: Tower Semiconductor Ltd., Migdal Haemek (IL)

(72) Inventors: Omer KATZ, Migdal Haemek (IL); Yakov Roizin, Afula (IL); Strum Avi, Haifa (IL)

(73) Assignee: Tower Semiconductor Ltd., Migdal Haemek (IL)

(21) Appl. No.: 19/211,265

(22) Filed: May 18, 2025

Related U.S. Application Data
(63) Continuation-in-part of application No. 18/967,630, filed on Dec. 3, 2024.

(51) Int. Cl. G02F 1/035

(52) U.S. Cl. CPC G02F 1/035; G02F 2201/305; G02F 2202/20

(57) ABSTRACT

A photonic integrated circuit that consists essentially of: a first die; and a second die that is bonded to the first die; wherein the first die includes a first silicon layer and an additional layer, a modulating electrode and a silicon nitride waveguide formed in the additional layer; and wherein the second die includes a patterned structure made of at least one electro-optical modulation material that is selected of lithium niobate, lithium titanate, barium titanate or graphene; wherein the patterned structure includes: an input region that is configured to receive radiation; a modulating region in which the radiation is modulated under a control of the modulating electrode to provide modulated radiation, and an output region that is optically coupled to the silicon nitride waveguide for providing the modulated radiation to the silicon nitride waveguide.

### CROSS REFERECE

This application is a continuation in part of U.S. patent application Ser. No. 18/967,630 filing date Dec. 3, 2024, which is incorporated herein by reference.

### BACKGROUND

Optical communication is capable of increasing the throughput of communication.

There is a growing need to manufacture integrated circuits in a cost effective manner.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a portion of a photonic integrated circuit;

FIG. 2 illustrates an example of a portion of a photonic integrated circuit;

FIG. 3 illustrates an example of a portion of a photonic integrated circuit;

FIG. 4 illustrates an example of a portion of a photonic integrated circuit;

FIG. 5 illustrates an example of phases of a manufacturing process of a photonic integrated circuit;

FIG. 6 illustrates an example of a phase of a manufacturing process of a photonic integrated circuit;

FIG. 7 illustrates an example of a method;

FIG. 8 illustrates an example of a method; and

FIG. 9 illustrates an example of a method.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY

A photonic integrated circuit and a method related to the photonic integrated circuit.

### DESCRIPTION OF THE PREFERRED EMBODIMENTS

According to an embodiment there is provided a photonic integrated circuit that consists essentially of at least one pair of a first die and a second die. According to an embodiment the least one pair forms a first wafer and a second wafer that are bonded to each other—for example—following a surface activation of buffering layers of the at least one pairs of first die and second die—without using a bonding material.

Examples of bonding one die to another, and/or examples for forming layers and/or structures within photonic integrated circuits are illustrated in U.S. patent application Ser. No. 18/967,630 filing date Dec. 3, 2024, which is incorporated herein by reference.

According to an embodiment, “consists essentially of” limits the scope of a claim to the specified materials or steps “and those that do not materially affect the basic and novel characteristic(s)” of the claimed invention.

According to an embodiment, the photonic integrated circuit does not include at least one triplets of dies—such a triplet may include a third die such as a dedicated III-V die.

Using pairs of dies, each consisting essentially of the first die and the second die decreases the cost and the complexity of the manufacturing the photonic integrated circuit.

It is costly and hard to pattern an electro-optical modulation layer-especially patterning the electro-optical modulation layer to form electro-optical modulation layer elements that match the silicon nitride waveguide. Receiving a patterned electro-optical modulation layer from another vendor reduces the cost and complexity of the manufacturing of the photonic integrated circuit and allows using third party wafers and/or dies that include an unpatterned electro-optical modulation layer.

According to an embodiment, the photonic integrated circuit includes patterned electro-optical elements such as patterned modulators, patterned waveguides, and the like. According to an embodiment the pattern are user for optical coupling—for example for edge coupling. Non-limiting examples of electrical-optical elements include diffraction grating, regions having a tapered shape, and the like. According to an embodiment one of the dies has a substrate that is being thinned, and openings are formed within the thinned substrate to expose contact pads.

According to an embodiment, the CMOS manufacturing process is not optimal for manufacturing the patterned electro-optical elements (for example due to contamination with non-CMOS friendly elements such as lithium)—and these patterned electro-optical elements are manufactured by another vendor to provide one die that is bonded to another die that is CMOS manufactured.

According to an embodiment, modulating the radiation within a patterned structure that is optically coupled to a silicon nitride waveguide—allows to reduce the dimensions of the silicon nitride waveguide (below and well below fifty till one hundred microns)—as modulation of the radiation within the silicon nitride waveguide (by changing the reflection index of the silicon nitride waveguide) required a silicon nitride waveguide of at least fifty till one hundred microns.

According to an embodiment, the photonic integrated circuit includes openings and/or spaces for effectively inserting light into the photonic integrating circuit, and/or for optically coupling the lights to external waveguides (fibers).

According to an embodiment, one or more regions are formed to function as spot size convertors between a waveguide of the photonic integrated circuit and an optical fiber, if coupling is done at the edge of one of the dies (edge coupling is also referred to as butt coupling). The one or more regions may have a tapered shape that has a width that gradually decreases thereby maintaining light in a fundamental mode and expanding the spot size to match a core diameter of the external waveguide (for example 8-10.5 microns).

According to an embodiment the one or more regions are formed in a certain die of the pair of dies at the ends of waveguides such as silicon nitride waveguide, or lithium niobate or lithium tantalate or barium titanate or graphene structures (such as waveguides). For example, such regions may be formed at both sides of the waveguides—one region facing the edge of the photonic integrated circuit and the other region is adjacent to a waveguide formed at another die of the pair of dies.

According to an embodiment, in order to prevent expanding the optical mode from overlapping with the bulk silicon, an undercut is formed. In this case, the undercut may be formed using an etching process that is made through recesses that are much smaller that the dimensions of the space formed by the etching process—see for example the etching process (referred to as onion etching) illustrated in U.S. Pat. No. 1,084,012,882 which is incorporated herein by reference.

According to an embodiment, the mentioned above etching process preceded the bonding of the first and second dies.

According to an embodiment, lights that propagates within the pair is outputted, using optical coupling to elements such as external waveguides and/or external sensors.

According to an embodiment, the electro-optical elements are made (or at least include) one or more electro-optical materials such as Lithium Niobate, Lithium Tantalate, Barium Titanate or Graphene).

According to an embodiment, the photonic integrated circuit consists essentially of a single pair of a first die and of the second die or consists essentially of multiple pairs of first and second dies.

According to an embodiment, there is provided a photonic integrated circuit that consists essentially of a first die and a second die that is bonded to the first die.

Each die may include multiple layers—for example, the first die may include a first silicon layer, and an additional layer, a modulating electrode and a silicon nitride waveguide formed in the additional layer. Yet for another example—the second die may include a patterned structure made of at least one electro-optical modulation material that is selected of lithium niobate, lithium tantalate, barium titanate or graphene.

According to an embodiment, the patterned structure is illustrated as including:
a. An input region that is configured to receive radiation.
b. A modulating region in which the radiation is modulated under a control of the modulating electrode to provide modulated radiation.
c. An output region that is optically coupled to the silicon nitride waveguide for providing the modulated radiation to the silicon nitride waveguide.

According to an embodiment, the modulating region is at least a portion of a waveguide.

According to an embodiment, the first die is a thinned first die that has undergone a thinning operation.

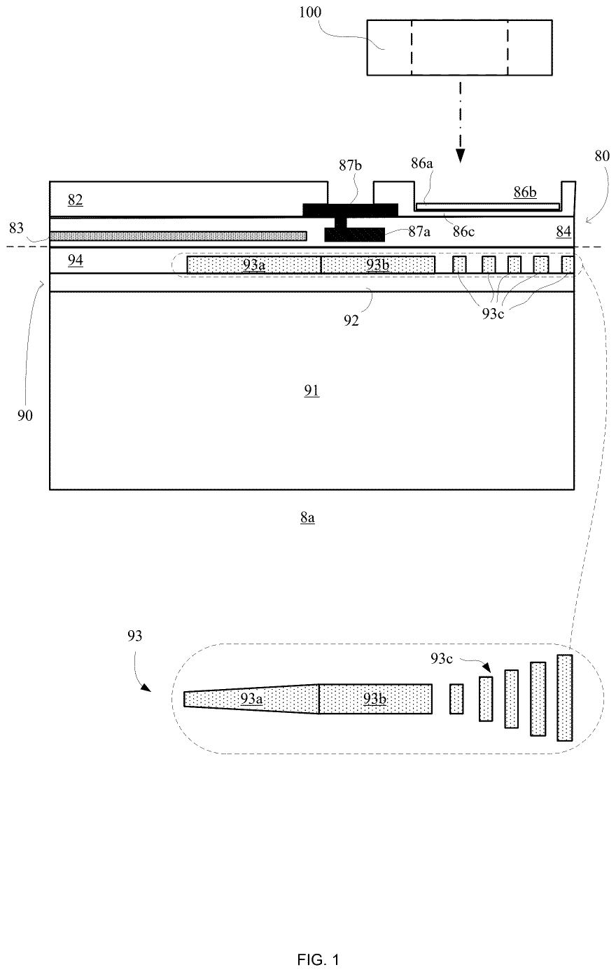

According to an embodiment, the input region is configured to receive radiation from a top of the photonic integrated circuit. See, for example, FIG. 1.

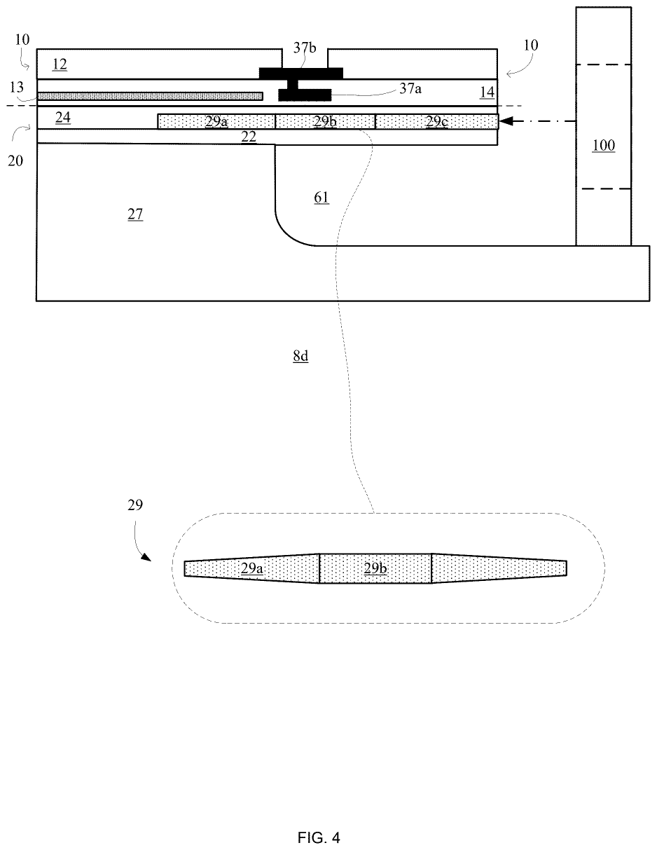

According to an embodiment, the input region has a tapered shape (see for example input region 29c of FIG. 4) or has another shape—for example includes spaced apart segments that form a diffraction grating (see for example input region 93c of FIG. 1). The tapered shape allows to maintain radiation in a fundamental mode and to change the width of the radiation spot—which compensates for the different sizes of the external waveguide core and the modulation region dimensions.

According to an embodiment, the output region has a tapered shape (see for example output regions 93a of FIGS. 1 and 29a of FIG. 4).

According to an embodiment, the input region (see for example output region 29a of FIG. 4). is configured to receive radiation from an edge (side) of the photonic integrated circuit.

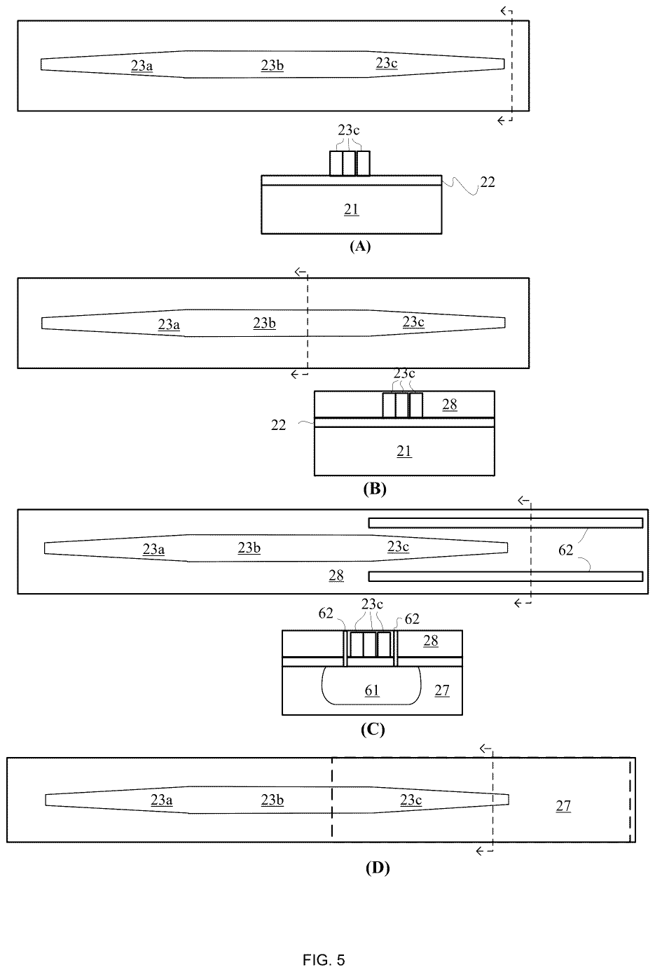

According to an embodiment, in this case (receiving radiation from the edge) at least one of the following is true:
a. An undercut (denoted 61 in FIGS. 4 and 5) is formed below the entirety of the input region. The undercut prevents expansion of the optical mode within the substrate.
b. The photonic integrated circuit includes a fiber holder (a portion of processed substrate 27 in which the undercut was formed) that is configured to hold a fiber (denoted 100 in FIG. 4) in a position where a center of a fiber is aligned within the input region.

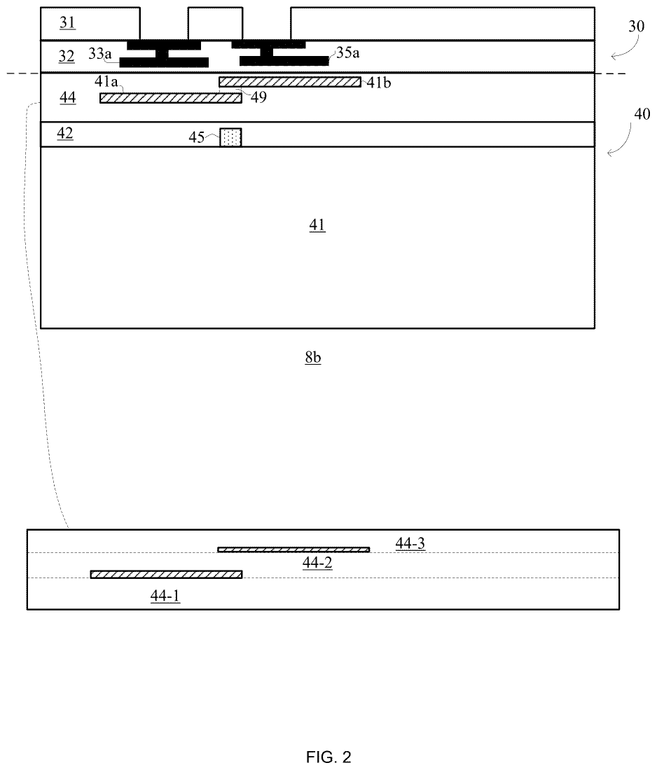

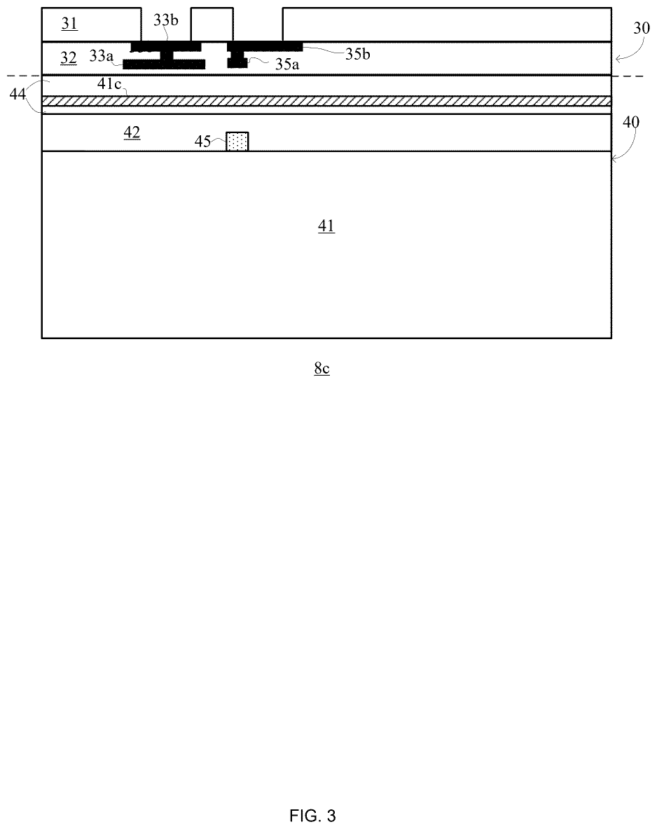

According to an embodiment there is provided a photonic integrated circuit that consists essentially of a first die and a second die that is bonded to the first die. The first die includes a first silicon layer and an additional layer, modulating electrodes formed in the additional layer. The second die includes a silicon nitride waveguide and one or more patterned graphene structures (see FIGS. 2 and 3). The one or more patterned graphene structures are configured to modulate, under a control of the modulating electrodes, radiation in the silicon nitride waveguide.

According to an embodiment, in this case (having one or more patterned graphene structures) the modulating electrodes (denoted 33a and 35a in FIGS. 3 and 4) are capacitively coupled without direct electrical contact to the one or more patterned graphene structures (denoted 41a and 41b in FIGS. 2 and 41c in FIG. 3) and the one or more patterned graphene structures are in (are positioned in) an evanescent field of the radiation in the silicon nitride waveguide (denoted 45 in FIGS. 2 and 3).

The absence of direct contact between the modulating electrodes and the patterned graphene structures is beneficial as there is no need to use Au/Ni contacts that may contaminate CMOS manufacturing facilities.

FIG. 1 illustrates an example of a photonic integrated circuit in which the radiation is provided from above.

The first die 80 includes silicon layer 82 (that may be a thinned silicon substrate) in which openings were formed to expose contact pad 87b that is electrically coupled (for example by via) to modulating electrode 87a.

Light from an external waveguide such as fiber 100 passes through a first die input portion 86c that is substantially transparent to the radiation. The first die input portion 86c is thinner than other parts of silicon layer 82—as illustrated by space 86b positioned above the first die input portion. In FIG. 1 there is an anti-reflective layer 86a formed above the first die input portion 86c. The radiation also passes through additional layer 84 and impinges in input region 93c that is illustrated as being a diffraction grating in FIG. 1. The silicon nitride waveguide 82, the modulating electrode 87a, a part of a via that is connected between the modulating electrode 87a and the contact pad 87b is formed in the additional layer 84.

The second die 90 includes substrate 91, oxide layer 92 and upper layer 94 in which the patterned structure 93 is formed. Any reference to an oxide may be applied mutatis mutandis to Tetraethyl orthosilicate (TEOS) or another oxide.

The upper layer may be formed by depositing oxide after the formation of the patterned structure and by polishing the oxide. If the polishing stops when reaching the patterned structure a thin oxide layer is deposited.

The patterned structure 93 includes input region 93c, modulation region 93b (illustrated as having a box shape) and output region 93a (having a tapered shape) that is located directly below (and is optically coupled to) a portion of the silicon nitride waveguide 83 of the first die 80. The silicon nitride waveguide is parallel to the patterned structure.

In FIG. 2, the first die 30 includes silicon layer 31 (that may be a thinned silicon substrate) in which openings were formed to expose contact pads 33b and 35b.

The contact pads 33b and 30b and modulating electrodes 33a and 35a (that are electrically coupled by vias to the modulating electrodes 33a and 35b) are formed in another layer 32 of the first die 30.

The second die includes substrate 41, first additional layer 42 (in which the silicon nitride waveguide 45 is positioned) and a second additional layer 42 in which the first patterned graphene structure 41a and the second patterned graphene structure 41b are positioned.

According to an embodiment, at least one of the following is true:
a. The formation of the silicon nitride waveguide 45 is followed by forming the first additional layer by oxide deposition and polishing.
b. The first patterned graphene structure 41a is formed on the oxide. For example—on an additional oxide layer denoted 44-1 in FIG. 2. Alternatively—the deposition of oxide following the formation of the silicon nitride waveguide 45 may proceed till forming the surface on which the first patterned graphene structure 41a is formed (for example—providing a single oxide layer that forms layers 42 and 44-1).
c. A thin layer (denoted 44-2 in FIG. 2) of SiO2 or hexagonal Boron Nitride is formed on the first patterned graphene structure 41a.
d. The second patterned graphene structure 41b is formed on the thin layer of SiO2 or hexagonal Boron Nitride.
e. The formation of the second patterned graphene structure 41b is followed by forming another layer (44-3) of oxide.

The first patterned graphene structure and the second patterned graphene structure are spaced apart from each other and partially overlap (in the sense that a portion of the first patterned graphene structure is located directly above a portion of the second patterned graphene structure) to provide a region 49 with electrical field.

According to an embodiment the overlap width is larger than the silicon nitride waveguide width. The total overlay region has a much smaller capacitance than capacitive coupling parts of the graphene layers to the modulating electrodes.

The first modulating electrode 33a and the second modulating electrode 35a are capacitively coupled to first and second patterned graphene structures. According to an embodiment, they may have the same capacitance.

The first modulating electrode and the second modulating electrode are located aside the overlap region. This is beneficial as there is no modulating electrode directly above the silicon nitride waveguide—which reduces the chances of unwanted dissipation of radiation that passes through the silicon nitride waveguide.

In FIG. 3, the first die 30 includes silicon layer 31 (that may be a thinned silicon substrate) in which openings were formed to expose contact pads 33b and 35b.

The contact pads 33b and 30b and modulating electrodes 33a and 35a (that are electrically coupled by vias to the modulating electrodes 33a and 35b) are formed in another layer 32 of the first die 30.

The second die includes substrate 41, first additional layer 42 (in which the silicon nitride waveguide 45 is positioned) and a second additional layer 42 in which patterned graphene structure 41c is positioned.

According to an embodiment the silicon nitride waveguide 45 is formed in the first die.

The second modulating electrode 35a has a capacitance that is smaller than a capacitance of the first modulating electrode 33a and is positioned directly above the silicon nitride waveguide.

The modulating electrodes are spaced apart (along the Z axis) from the patterned graphene structure 41c at a distance (for example 100-300 nanometer) that does not lead to significant losses in the SiN waveguide. This may require to use a higher modulating voltage: typical vertical fields to modulate graphene are of the order of 5E6V/cm. With 100 nm distance between the modulating electrodes and the patterned graphene structure 41c, the modulating voltage is expected at the level of 50V.

The modulation voltage drops at the capacitance of second modulating electrode 35a (as it has a capacitance that is smaller than the capacitance of graphene to the first modulating electrode that is connected to it in series. Thus, the vertical field that leads to Pauli blocking in the graphene layer under the second modulating electrode 35a is generated in the capacitor of the modulating electrode 35a. The distance between the modulating electrode 35a is larger than the, distance of SiN waveguide to the graphene layer.

In FIGS. 2 and 3, the radiation may reach the photonic integrated circuit from the top or from the side.

FIGS. 1 and 4 illustrate a different modulation scheme that the modulations scheme of FIGS. 2 and 3. In FIG. 2 and FIG. 3 the silicon nitride waveguide receives a non-modulated radiation which is modulated using the one or more patterned graphene structures. In FIGS. 1 and 4 the silicon nitride waveguide receives a modulated radiation.

FIG. 4 illustrates an example of a photonic integrated circuit in which the radiation is provided from above.

The first die 10 includes silicon layer 12 (that may be a thinned silicon substrate) in which an opening was formed—to expose contact pad 37b that is electrically coupled (for example by via) to modulating electrode 37a.

Light from an external waveguide such as fiber 100 is provided from the edge (side) of the photonic integrated circuit while the fiber 100 is held by a fiber holder (a portion of processed substrate 27 in which an undercut 61 was formed). The fiber is held in a position where a center of a fiber is aligned within an input region 29c.

The first die 10 also includes an additional layer 14 in which the silicon nitride waveguide 82, the modulating electrode 87a, and a part of a via (that is connected between the modulating electrode 87a and the contact pad 87b) are formed.

The second die 20 includes processed substrate 27, oxide layer 22 and upper layer 24 in which the patterned structure 29 is formed. The patterned structure 29 includes input region 29c (having a tapered shape), modulation region 29b (illustrated as having a box shape) and output region 29a (having a tapered shape). The output region is located directly below (and is optically coupled to) a portion of the silicon nitride waveguide 13 of the first die 10. The silicon nitride waveguide is parallel to the patterned structure.

FIG. 5 illustrates multiple phases of a manufacturing process of second die 20 of FIG. 4. For simplicity of explanation the output region (denoted 23a) is not shown in FIG. 5. FIG. 5 includes top views and cross sections.

Section (A) illustrates a completion of a formation of pattern 23. Section (A) includes a top view and a view from a side of a cross sectioned intermediate (not fully manufactured) second die. The cross section view also illustrate oxide layer 22 and substrate 21.

Section (B) illustrates a completion of an oxide top cladding (denoted 28) followed by Chemical Mechanical Polishing. Section (B) includes a top view and a view from a side of another cross sectioned intermediate (not fully manufactured) second die.

Sections (C) and (D) illustrate the formation of slots 62 in the oxide top cladding and the oxide layer, and the outcome of the onion etching (through the slots) to provide undercut 61 in the processed substrate 27. Following the etching the second die is bonded to the first die.

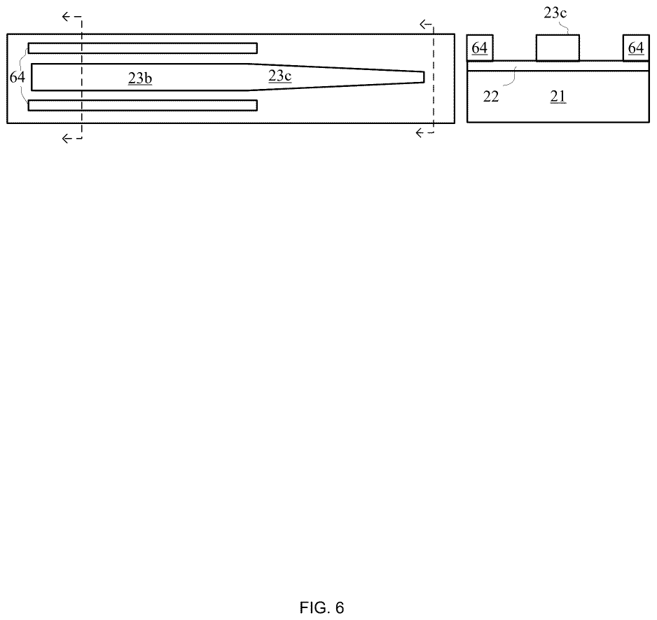

FIG. 6 illustrates section (A)—in which modulating electrodes 64 are formed at the same plane of the silicon nitride waveguide. In FIG. 4 the silicon nitride waveguide was formed in another plane.

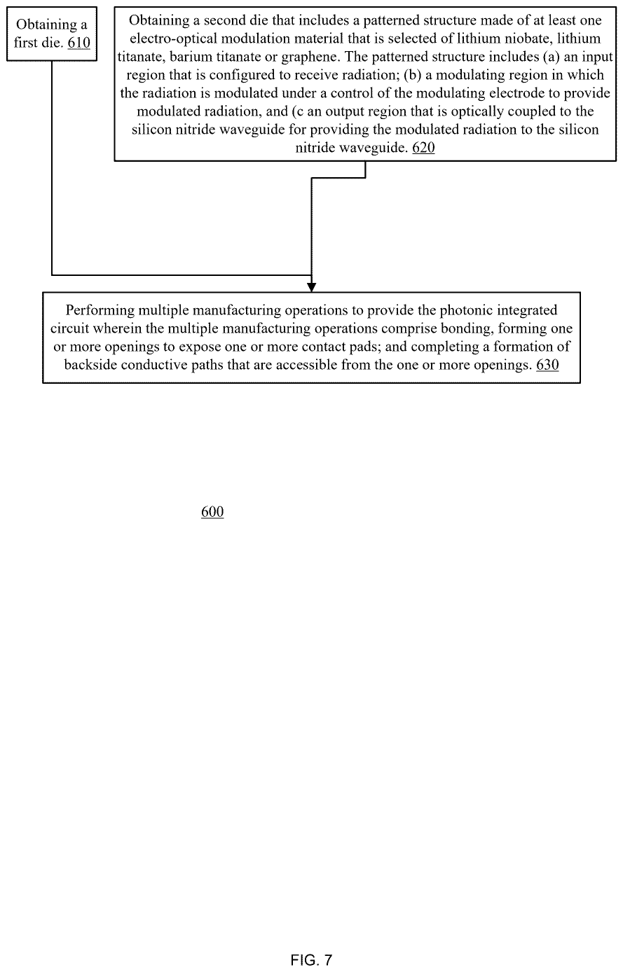

FIG. 7 illustrates an example of method 600 for manufacturing a photonic integrated circuit.

Method 600 includes steps 610 and 620 that are followed by step 630.

Step 610 includes obtaining a first die.

Step 620 includes obtaining a second die that comprises a patterned structure made of at least one electro-optical modulation material that is selected of lithium niobate, lithium titanate, barium titanate or graphene; wherein the patterned structure comprises: an input region that is configured to receive radiation; a modulating region in which the radiation is modulated under a control of the modulating electrode to provide modulated radiation, and an output region that is optically coupled to the silicon nitride waveguide for providing the modulated radiation to the silicon nitride waveguide.

Step 630 includes performing multiple manufacturing operations to provide the photonic integrated circuit wherein the multiple manufacturing operations comprise bonding, forming one or more openings to expose one or more contact pads; and completing a formation of backside conductive paths that are accessible from the one or more openings. Any steps mentioned in relation to any of the previous figures and/or in U.S. patent application Ser. No. 18/967,630 filing date Dec. 3, 2024, which is incorporated herein by reference may be included in step 630.

FIG. 8 illustrates an example of method 700 for operating a photonic integrated circuit that includes one or more graphene structures (see, for example FIGS. 2 and 3).

Method 700 includes a sequence of steps 710, 720, 720 and 730.

According to an embodiment, step 710 includes receiving optical signals by a silicon nitride waveguide that is optically coupled to a patterned structure made of an electro-optical modulation material that is selected of lithium niobate, lithium titanate or barium titanate.

According to an embodiment, step 710 is preceded by (a) receiving optical signals by an input region of a patterned structure made of an electro-optical modulation material that is selected of lithium niobate, lithium titanate or barium titanate, and (b) providing the optical signals from an output region of the patterned structure to the silicon nitride waveguide, using optical coupling.

The optical signals may be provided using an optical coupling between the silicon nitride waveguide and an output region of a structured pattern.

According to an embodiment, step 720 includes conveying optical signals by the silicon nitride waveguide.

According to an embodiment, step 730 includes modulating, using one or more graphene structures, the optical signals.

According to an embodiment, step 740 includes conveying the modulated optical signals by the silicon nitride waveguide.

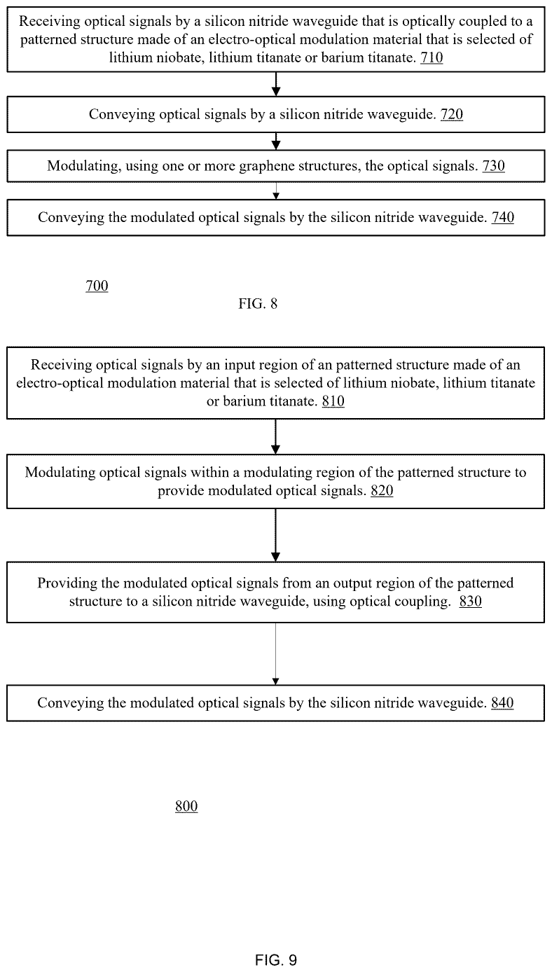

FIG. 9 illustrates an example of method 800 for operating a photonic integrated circuit such as those illustrated in FIG. 1 or 4.

Method 800 includes a sequence of steps 810, 820, 830 and 840.

According to an embodiment, step 810 includes receiving optical signals by an input region of a patterned structure made of an electro-optical modulation material that is selected of lithium niobate, lithium titanate or barium titanate.

According to an embodiment, step 820 includes modulating optical signals within a modulating region of the patterned structure to provide modulated optical signals.

According to an embodiment, step 830 includes providing the modulated optical signals from an output region of the patterned structure to a silicon nitride waveguide, using optical coupling.

According to an embodiment, step 840 includes conveying the modulated optical signals by the silicon nitride waveguide.

Any reference to any of the terms “comprise”, “comprises”, “comprising” “including”, “may include” and “includes” may be applied mutatis mutandis to any of the terms “consists of”, “consisting”, “consisting essentially of”. For example—any of the rectifying circuits illustrated in any figure may include more components than those illustrated in the figure, only the components illustrated in the figure or substantially only the components illustrated in the figure.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “proximal”, “distal”, “front”, “back,” “top”, “bottom”, “over”, “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A photonic integrated circuit that consists essentially of:
a first die; and
a second die that is bonded to the first die;
wherein the first die comprises a first silicon layer and an additional layer, modulating electrodes formed in the additional layer; and
wherein the second die comprises a silicon nitride waveguide and one or more patterned graphene structures; and
wherein the one or more patterned graphene structures are configured to modulate, under a control of the modulating electrodes, radiation in the silicon nitride waveguide.

18. (canceled)

19. The photonic integrated circuit according to claim 17, wherein the graphene layer is in the evanescent field of the radiation in the silicon nitride

20. The photonic integrated circuit according to claim 17, wherein one or more patterned graphene structures consist of a single patterned graphene structure.

21. The photonic integrated circuit according to claim 20, wherein the modulating electrodes comprises a first modulating electrode and a second modulating electrode that has a capacitance that is smaller than a capacitance of the first modulating electrode.

22. The photonic integrated circuit according to claim 21, wherein the second modulating electrode is positioned directly above the silicon nitride waveguide.

23. The photonic integrated circuit according to claim 17, wherein one or more patterned graphene structures consist of a first patterned graphene structure and a second patterned graphene structure.

24. The photonic integrated circuit according to claim 18, wherein the first patterned graphene structure and the second patterned graphene structure are spaced apart from each other and partially overlap to provide a region with electrical field

25. The photonic integrated circuit according to claim 24, wherein the modulating electrodes comprise a first modulating electrode and a second modulating electrodes capacitively coupled to first and second patterned graphene structures

26. The photonic integrated circuit according to claim 24, wherein a proximal portion of the first modulating electrode and a proximal portion of the second modulating electrode are located aside the overlap region.

27. The photonic integrated circuit according to claim 17 that consists essentially of a single pair of a first die and of the second die.

28. The photonic integrated circuit according to claim 17 that comprises multiple pairs, each pair is formed by the first die and the second die.

29. (canceled)

30. A method for operating a photonic integrated circuit, the method comprises:
receiving optical signals by a silicon nitride waveguide that is optically coupled to a patterned structure made of an electro-optical modulation material that is selected of lithium niobate, lithium titanate or barium titanate;
conveying the optical signals by the silicon nitride waveguide;
modulating the optical signals, using one or more graphene structures to provide modulated optical signals; and
conveying the modulated optical signals by the silicon nitride waveguide.

31. The method according to claim 30 wherein the photonic integrated circuit consists essentially of a first die; and a second die that is bonded to the first die; wherein the first die comprises a first silicon layer and an additional layer, modulating electrodes formed in the additional layer; and wherein the second die comprises the silicon nitride waveguide and the one or more patterned graphene structures.

32.
